(19) United States
(12) Patent Application Publication
(10) Pub. No.: US 2023/0061788 A1
(43) Pub. Date: Mar. 2, 2023

(54) WORK MACHINE WITH COMPONENT COOLING MEANS

(71) Applicant: Caterpillar SARL, Geneva (CH)

(72) Inventors: Kazumasa MATSUMURA, Akashi-shi (JP); Keitaro YOKOGAWA, Kasai-shi (JP); Naoya SHIBAHARA, Kobe-shi (JP)

(73) Assignee: Caterpillar SARL, Geneva (CH)

(21) Appl. No.: 17/794,853

(22) PCT Filed: Jan. 15, 2021
(86) PCT No.: PCT/EP2021/025011

§ 371 Date: Jul. 22, 2022

(30) Foreign Application Priority Data
Jan. 23, 2020 (JP) 2020-009296

(51) Int. Cl. E02F 9/08; B60K 11/08

(52) U.S. Cl. CPC E02F 9/0891; B60K 11/08; B23K 26/21

(57) ABSTRACT

To provide a work machine in which a filter can be manufactured at low costs and can be fitted into various shapes. A work machine comprises a cover member configured to partition a machine room in which at least a part of a cooling core is housed. The work machine comprises an opening part formed in the cover member, and configured to take-in an air for cooling the cooling core into the machine room. The work machine comprises a plain-woven wire mesh welded and attached to a position from the opening part to the cooling core, and configured to form a filter that prevents inclusion of dust into the machine room from the opening part.

### TECHNICAL FIELD

The present invention relates to a work machine comprising a filter configured to prevent inclusion of dust from an opening part into a room, wherein the opening part is formed in a cover member and configured to take in an air for cooling a cooled part into the room.

### BACKGROUND OF THE INVENTION

In work machines such as hydraulic excavators, an opening part for taking cooling air therethrough into a cooling package such as a radiator and an oil cooler is formed in an outer cover. This opening part is constituted of a punching metal lined up with small holes, or a louver-shaped member, or the like, in order to prevent damage to a cooling core.

In some work sites of work machines, a fine mesh screen (filter) may be installed at the opening part or between the opening part and the cooling core, in order to prevent clogging or damage to the cooling core due to dust (See, for example, Patent Literature 1).

### PRIOR ART LITERATURES

### Patent Literatures

[PATENT LITERATURE 1] Japanese Patent Application Laid-Open No. 2010-65466

### SUMMARY OF THE INVENTION

### Problems to be Solved by the Invention

As fine mesh screens, there are some using a plain-woven wire mesh. The plain-woven wire mesh is formed in such a manner that vertical wires and lateral wires of thin metal wires are interwoven to form a net shape. Therefore, when attaching the plain-woven wire mesh to a vehicle body, the frame body and the plain-woven wire mesh are fixed together by sandwiching the plain-woven wire mesh by the frame body usually formed by performing hemming process on four sides thereof, and the frame body is fixed to the machine body with bolts or the like.

Because of expensiveness of this hemming process, and for technical reasons of bending and sandwiching the frame body if it is relatively large, the frame body is forced to have a linear shape. For this reason, the frame body needs to have a simple quadrangular shape, and it was difficult to manufacture a screen or the like that is matched to an opening part having a complicated polygonal shape, or that fits snugly to an air duct having a complicated shape.

Further, since work-hardening is generated in a frame body has been subjected hemming process, the frame body may be damaged when attempting to perform additional bending process on the frame body. For this reason, it was difficult to machine the frame body into a shape that fits the opening part of the cover having a curved surface shape.

The present invention has been made in view of these points, and it is an object of the present invention to provide a work machine having a filter that can be manufactured at low costs and can be fitted into various shapes.

### Means for Solving the Problems

The present invention described in claim 1 is a work machine comprising: a cover member configured to partition a room in which at least a part of a cooled part is housed; an opening part formed in the cover member, and configured to take in an air for cooling the cooled part into the room; a plain-woven wire mesh welded and attached to a position from the opening part to the cooled part, and configured to form a filter that prevents inclusion of dust into the room from the opening part.

The present invention described in claim 2 is the work machine described in claim 1, wherein the plain-woven wire mesh is attached by at least either one of a seam-welding and a laser-welding.

The present invention described in claim 3 is the work machine described in claim 1 or 2, comprising a frame body formed in a frame shape so as to surround the plain-woven wire mesh, and arranged at a position from the opening part to the cooled part, wherein the plain-woven wire mesh is attached by welding an outer edge portion to the frame body.

The present invention described in claim 4 is the work machine described in claim 3, the frame body is formed in a frame shape by laser-welding a flat plate.

The present invention described in claim 5 is the work machine described in claim 1 or 2, wherein the plain-woven wire mesh is directly attached by welding to the cover member.

### Favorable Effects of the Invention

According to the present invention described in claim 1, it is not necessary to arrange a plain-woven wire mesh by using a hemmed frame body, for example, and the filter can be manufactured at low costs, and the filter can be fitted into various shapes, such as an opening part in a polygonal shape.

According to the present invention described in claim 2, the plain-woven wire mesh can be firmly welded by a simple method.

According to the present invention described in claim 3, by detachable attaching the frame body to the cover member, the frame body can be easily attached and detached at the time of cleaning, and even if replacement is required, a minimal replacement is only required, and as a result, it becomes economical.

According to the present invention described in claim 4, there is no level difference even at positions of welding spots where the plain-woven wire mesh is welded to the frame body, and thus the plain-woven wire mesh can be satisfactorily welded to the frame body.

According to the present invention described in claim 5, the appearance becomes excellent, and the number of parts can be suppressed, thereby enabling the manufacture to be made at lower costs.

### BRIEF DESCRIPTION OF THE DRAWINGS

FIG. 1 is a front view illustrating a part of a first embodiment of a work machine according to the present invention.

FIG. 2 is a front view illustrating a cover member of the same work machine as the above.

FIG. 3 is a front view illustrating a part of the same work machine as the above.

FIG. 4 is a front view illustrating a part of a frame body of the same work machine as the above.

FIG. 5 is a side view illustrating the same work machine as the above.

FIG. 6 is a schematic explanatory view of welding spots of a plain-woven wire mesh of the same work machine as the above.

FIG. 7 is a schematic explanatory view of welding spots of a plain-woven wire mesh of a work machine by way of a comparative example.

FIG. 8 is a back view illustrating a part of a second embodiment of a work machine according to the present invention.

FIG. 9 is a back view illustrating a cover member of the same work machine as the above.

FIG. 10 is a schematic explanatory view of welding spots of a plain-woven wire mesh illustrating a third embodiment of a work machine according to the present invention.

FIG. 11 is a schematic explanatory view of welding spots of a plain-woven wire mesh illustrating a fourth embodiment of a work machine according to the present invention.

FIG. 12 is a schematic explanatory view of welding spots of a plain-woven wire mesh illustrating a fifth embodiment of a work machine according to the present invention

### DETAILED DESCRIPTION OF THE INVENTION

Hereinbelow, the present invention will be described in detail based on respective embodiments illustrated in the drawings.

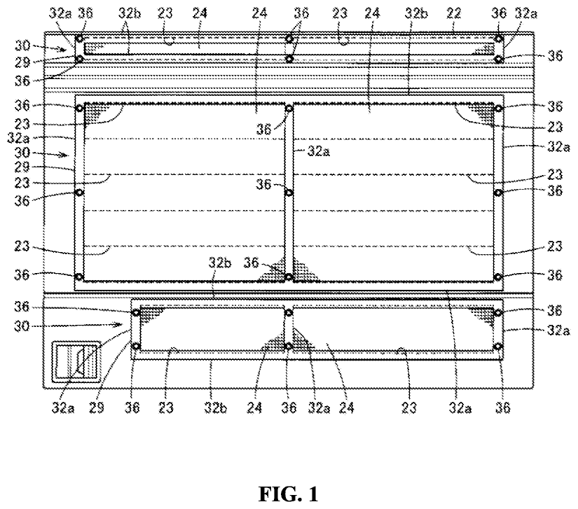

A first embodiment illustrated in FIGS. 1 to 6 will be first described.

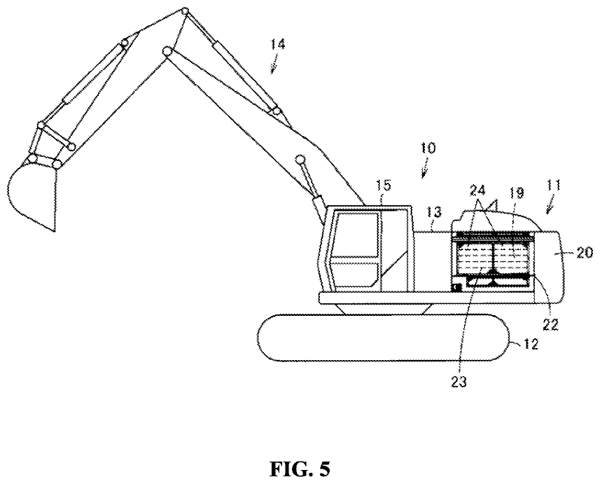

As illustrated in FIG. 5, a work machine 10 such as a hydraulic excavator type is configured such that a machine body 11 comprises a lower traveling body 12 and an upper swiveling body 13 swingably provided on the lower traveling body 12, and a work device 14 such as a bucket type is mounted on the upper swiveling body 13 of the machine body 11.

A cab 15 with a driver seat for operator is provided on the upper swiveling body 13. Further, on the upper swiveling body 13, a fuel tank and a hydraulic oil tank, and the like are provided at the opposite side to the cab 15 with the work device 14 interposed therebetween. Moreover, a machine room (engine room) 19 as a room is installed in a rear part of a swiveling bearing portion of the upper swiveling body 13, and a counterweight 20 is installed at a further rear part thereof.

An engine is installed in the machine room 19, and a pump driven by the engine is arranged on one side of the engine, or on the right side in this embodiment. By controlling the supply and discharge of pressure oil from this pump to various hydraulic actuators by a control valve, traveling by the lower traveling body 12, swiveling of the upper swiveling body 13, and operation of the work device 14 are controlled.

Further, in the machine room 19, a cooling fan driven by the engine is arranged on the other side of the engine, or on the left side in this embodiment. Moreover, a cooling core as a cooled part is arranged on the side of the cooling fan on the opposite to the engine, or on the left side in the present embodiment. The cooling core is a package in which a plurality of heat exchangers such as a radiator, an oil cooler, and an intercooler are integrally formed.

The machine room 19 is covered and partitioned by a cover member 22. An opening part 23 is formed in the cover member 22, and a plain-woven wire mesh 24 forming a filter to prevent intrusion of dust from the opening part 23 into the machine room 19 is arranged, at a position from the opening part 23 to the cooling core, i.e., at a position of the opening part 23 or between the opening part 23 and the cooling core.

The cover member 22, in the present embodiment, is a door trim that opens and closes the machine room 19. Further, the cover member 22 is used for an outer cover forming an outer shell of the machine body 11. The cover member 22 is formed of metal. Although the cover member 22 is approximately formed in a flat plate shape, the cover member 22 is not limited to this but a curved portion or the like corresponding to the design of the machine body 11 may be formed. Further, although the cover member 22 is formed in an approximately quadrangular shape, the cover member 22 is not limited to this but may be given a shape corresponding to the shape of the machine room 19.

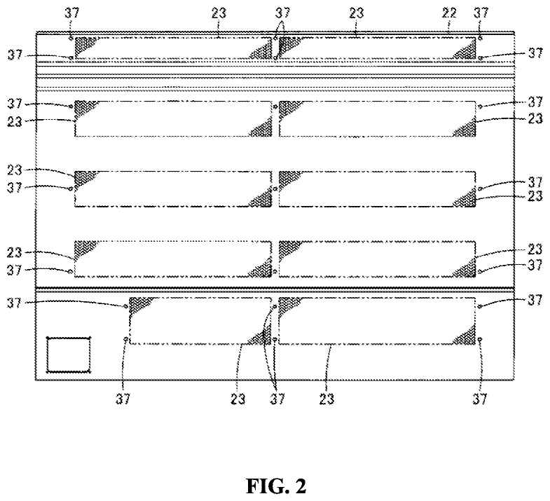

As illustrated in FIG. 1 and FIG. 2, the opening part 23 is formed so as to penetrate the cover member 22 in a thickness direction. The single or the plurality of opening parts 23 are formed in the cover member 22. In the present embodiment, the opening parts 23 are formed at a plurality of locations in the cover member 22. In the illustrated example, the plurality of opening parts 23 are formed in a vertical direction and in a width direction of the cover member 22, respectively. In the present embodiment, the opening parts 23 are formed with a large number of punched holes having a plurality of small round shapes or hexagonal shapes or other shapes being adjacently arranged within a region in a predetermined shape, for example, a quadrangular shape. Without being limited to this, the opening parts 23 may be formed by hollowing out the cover member 22 into a predetermined shape. The opening parts 23 may be formed so that their sizes or distribution ranges do not match those of the plain-woven wire meshes 24, in order to secure the strength of the cover member 22 and to share in common with the usage that does not require the plain-woven wire meshes 24. In other words, a relationship between the shapes of the opening parts 23 and the shapes of the plain-woven wire meshes 24 does not matter, if an air duct, which is not covered by the plain-woven wire meshes 24, is not formed between the opening parts 23 and the cooling core.

The plain-woven wire meshes 24 may have any given shape that fits a position where it is mounted, but in the present embodiment, it is formed in a quadrangular shape having, for example, two sides along the vertical direction and two sides along the width direction.

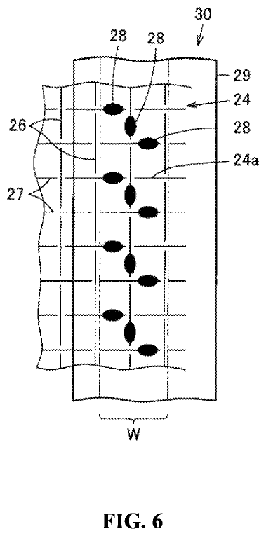

As illustrated in FIG. 6, the plain-woven wire mesh 24 is configured by combining a plurality of metal wire rods having a predetermined wire diameter in a grid pattern. The plain-woven wire mesh 24 is formed as wire meshes having a mesh of a predetermined size in such a manner that vertical wire rods 26, serving as one metal wire rods, arranged along a predetermined one direction, for example, a vertical direction; and lateral wire rods 27, serving as another metal wire rods, which are arranged along a predetermined other direction intersecting or orthogonal to the predetermined one direction, for example, along the width direction are interwoven alternately. In FIG. 6, for clarifying the description, the vertical wire rods 26 and the lateral wire rods 27 of the plain-woven wire mesh 24 is illustrated by breaking the portions on the back sides with respect to the paper surface at their intersection positions with each other.

The plain-woven wire mesh 24 is formed so that the intervals between the vertical wire rods 26, 26 and the intervals between the lateral wire rods 27, 27 substantially coincide with each other. Therefore, the plain-woven wire mesh 24 has meshes which are formed into substantially square shape. Further, the plain-woven wire mesh 24 is interwoven so that the lateral wire rods 27 are arranged zigzag as sandwiching the vertical wire rods 26 at the cut end face along the vertical direction, and the vertical wire rods 26 are arranged zigzag as sandwiching the lateral wire rods 27 at the cut end face along the width direction.

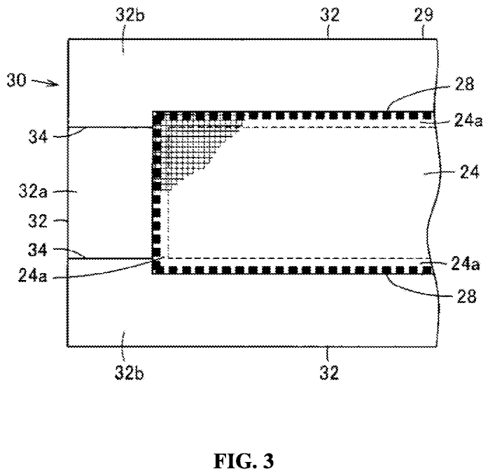

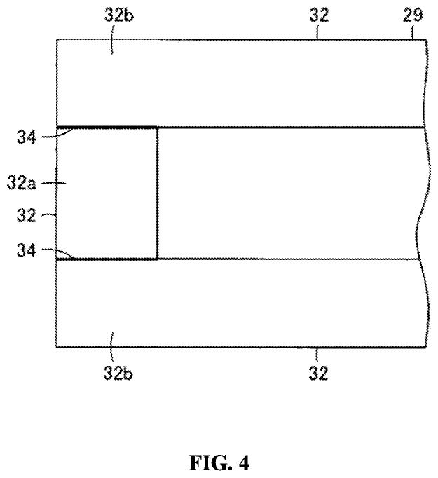

Then, as illustrated in FIG. 3, the plain-woven wire mesh 24 is attached to a frame body 29 by attaching outer edge portions 24a to the frame body 29 by welding spots 28 that are formed by a welding, thus making up of a screen filter 30 together with the frame body 29. In the present embodiment, the plain-woven wire mesh 24 is attached to the frame body 29 by at least either one of the seam-welding and the laser-welding. The frame body 29 is formed so as to surround the plain-woven wire mesh 24. The frame body 29 is preferably formed so that there is no level difference in a thickness direction, in order to make it possible to attach the plain-woven wire mesh 24 by the seam-welding and/or the laser-welding. In the present embodiment, the frame body 29 is formed by combining a plurality of thin plate-like flat plates 32 each having equal or substantially equal thicknesses. Preferably, the frame body 29 is formed by laser-welding band-shaped flat plates 32. In an example illustrated in FIG. 4, the frame body 29 is formed in a frame shape in such a manner that both ends of one linearly formed flat plate 32a are laser-welded to sides of the other linearly formed flat plate 32b, 32b respectively, at positions of welding spots 34, 34. The frame body 29 is not limited to this configuration, but may be configured otherwise as long as the ends of a plurality of the flat plates 32 are laser-welded in a frame shape. Further, the frame body 29, if its shape is large, may be additionally provided with an auxiliary flat plate 32. For example, the auxiliary flat plate 32 is arranged so as to be bridged between long-sized flat plates 32. In an example illustrated in FIG. 1, one auxiliary flat plate 32a is arranged between the intermediate portions of the other flat plates 32b, 32b, and both ends of the one flat plate 32a are laser-welded to the other flat plates 32b, 32b. The one auxiliary flat plate 32a is not limited to one, but a plurality of auxiliary flat plates may be arranged. The frame body 29 may be formed by hollowing out from a large flat plate by a laser cutting or the like.

Then, the frame body 29 is arranged at a position from the opening part 23 to the cooling core by means of mounting members 36. The mounting members 36 are bolts, for example. In the present embodiment, the mounting members 36 are screwed into the mounting holes 37 (FIG. 2) as mounted portions which are formed in the cover member 22 so that the frame body 29 is fixed to the cover member 22. As a result, the plain-woven wire meshes 24 (screen filters 30) are attached at a position from the opening parts 23 to the cooling core. In the present embodiment, the plain-woven wire meshes 24 and the frame bodies 29 (screen filters 30) together with the cover member 22 constitute a door panel for opening and closing the machine room 19 (FIG. 5). The plain-woven wire meshes 24 and the frame bodies 29 (screen filters 30) are arranged outside the cover member 22. That is, the plain-woven wire meshes 24 and the frame bodies 29 (screen filters 30) are located on the opposite side of the cooling core relative to the opening parts 23 or the cover member 22. In other words, the plain-woven wire meshes 24 and the frame bodies 29 (screen filters 30) are arranged on the upstream side of the air (cooling air) taken in from the opening parts 23, with respect to the opening parts 23.

Then, FIG. 6 illustrates an example in which the outer edge portion 24a of the plain-woven wire mesh 24 is seam-welded to the frame body 29. The plain-woven wire mesh 24 is configured such that all the vertical wire rods 26 and the lateral wire rods 27 are preferably seam-welded to the frame body 29 by spot-like welding spots 28. Now, from the fact that the plain-woven wire mesh 24 is configured such that each vertical wire rod 26 crosses alternately above and below every lateral wire rod 27 and vice versa, each vertical wire rod 26 and each lateral wire rod 27 are enabled to come into contact with the surface of the frame body 29 in every other mesh, but are separated from the surface of the frame body 29 at each intermediate position between these meshes, since each lateral wire rod 27 and each vertical wire rod 26 are interposed between the surface of the frame body 29 and each vertical wire rod 26/each lateral wire rod 27.

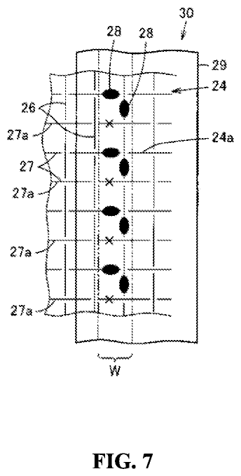

Therefore, as in a comparative example illustrated in FIG. 7, in a case where a width W (indicated by two-dot chain line) in such a direction as to cross a welding direction of a disk-shaped electrode at the tip portion of the seam-welding machine is set at one mesh of the plain-woven wire mesh 24, the portions away from the surface of the frame body 29 indicated by x are not welded to the frame body 29, with the result that a portion of each lateral wire rod 27 (lateral wire rod 27a) is not welded to the frame body 29. Thus, in the present embodiment, as illustrated in FIG. 6, by setting the width W (indicated by two-dot chain line) in such a direction as to cross a welding direction of a disk-shaped electrode at the tip portion of the seam-welding machine at a width of two or more meshes of the plain-woven wire mesh 24, all the vertical wire rods 26 and the lateral wire rods 27 can be seam-welded and attached to the frame body 29 by the welding spots 28.

In this manner, in the present embodiment, by welding and attaching the plain-woven wire mesh 24 forming the filter to a position from the opening part 23 formed in the cover member 22 to the cooling core, the need to arrange the plain-woven wire mesh 24 using the frame body or the like which was subjected to hemming process as conventional is eliminated, and the filter can be manufactured at low costs, and the filter can be fitted into various shapes such as a polygonal opening part 23 which was difficult to do so by hemming process. By using the plain-woven wire mesh 24 as the filter, a fine mesh can be obtained, thereby effectively preventing the inclusion of dust into the machine.

In addition, when welding the plain-woven wire mesh 24, the plain-woven wire mesh 24 can be firmly welded by a simple method by using at least either one of the seam-welding and the laser-welding.

Moreover, by welding and attaching the plain-woven wire mesh 24 to the frame body 29 composed of the flat plate 32, the frame body 29 can be detachably attached to the machine body 11 such as the cover member 22. As a result, economical merit is obtained since the frame body 29 can be easily attached and detached at the time of cleaning, and even if its replacement is required, only a minimal replacement is required.

When the plain-woven wire mesh 24 is seam-welded and/or laser-welded to the frame body 29, if the frame body 29 has a structure in which the flat plates are and welded while being overlapped at corners, for example, then a level difference is produced on the flat plates, and a gap is created between the plain-woven wire mesh 24 and the frame body 29 at the level difference portion and thus there is a risk that the plain-woven wire mesh 24 cannot be welded to the frame body 29. For this reason, by laser-welding band-shaped flat plates 32 and forming the frame body 29 into a frame shape, there is no level difference even at the positions of the welding spots 34, and the plain-woven wire mesh 24 can be welded satisfactorily to the frame body 29.

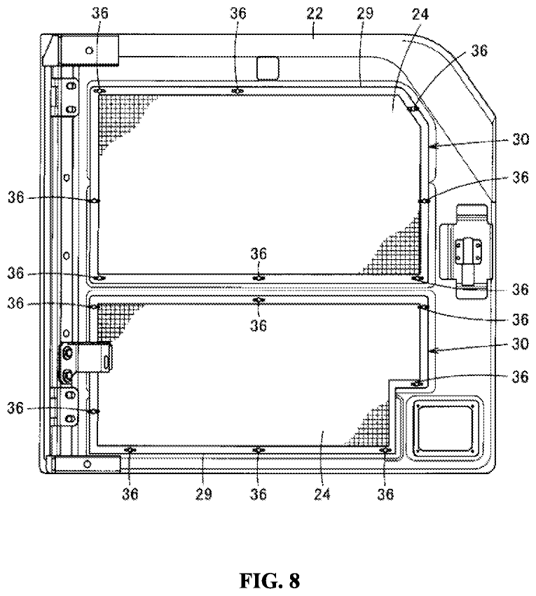

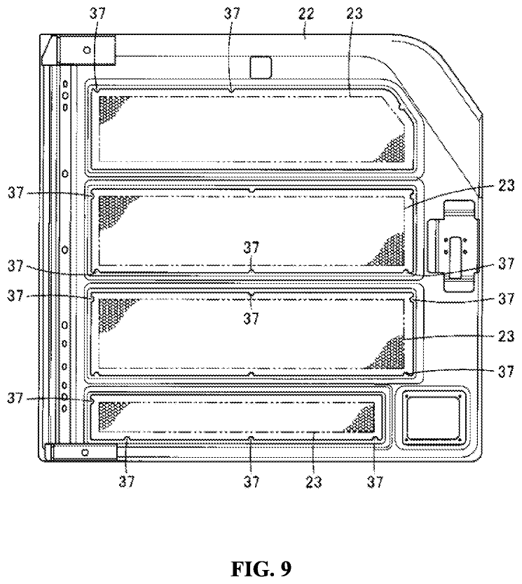

Next, a second embodiment illustrated in FIG. 8 and FIG. 9 will be described. The same parts as those in the embodiment illustrated in FIGS. 1 to 6 are designated by the same reference numerals to simplify the description.

In this second embodiment, the plain-woven wire mesh 24 and the frame body 29 (screen filter 30) are arranged inside the cover member 22. That is, the plain-woven wire mesh 24 and the frame body 29 (screen filter 30) are located on the same side as the cooling core relative to the opening part 23 or the cover member 22. In other words, the plain-woven wire mesh 24 and the frame body 29 (screen filter 30) are arranged on the downstream side of the air (cooling air) taken in from the opening part 23, with respect to the opening part 23.

Even in a case in which the plain-woven wire mesh 24 forming the filter is welded and attached to the inside of the cover member 22, in this manner, the same functions and effects as those of the aforementioned first embodiment can be exhibited, which include the ability to manufacture the filters at low costs as well as to fit the filters into various shapes, such as the opening part 23 in a polygonal shape, which was difficult to do so through the hemming process. That is, even if the plain-woven wire mesh 24 is welded and attached at any given position from the opening part 23 to the cooling core, the same functions and effects as those of this embodiment can be obtained.

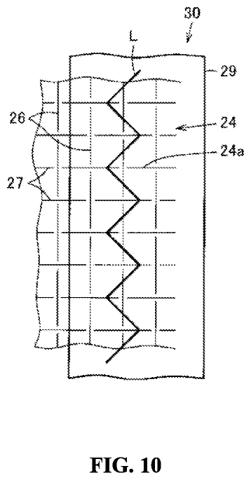

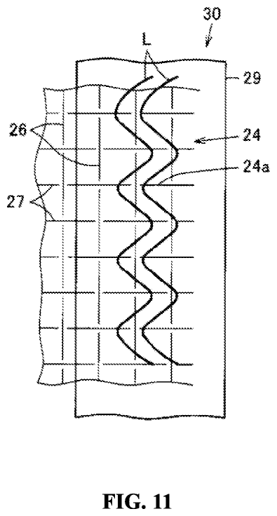

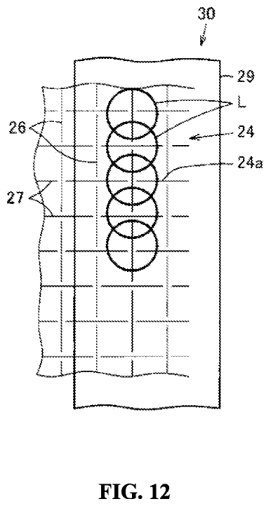

In the aforementioned respective embodiments, if the plain-woven wire mesh 24 is laser-welded to the frame body 29, the plain-woven wire mesh 24 is welded only at point positions where the plain-woven wire mesh 24 crosses a laser light, and at positions where the plain-woven wire mesh 24 comes into contact with the frame body 29. For example, if the laser light L is formed into a zigzag shape as in the third embodiment illustrated in FIG. 10, or if the laser light L is formed into a wavy shape as in the fourth embodiment illustrated in FIG. 11, or if the laser light L is formed into a circular shape as in the fifth embodiment illustrated in FIG. 12, both the vertical wire rods 26 and the lateral wire rods 27 of the plain-woven wire mesh 24 can be welded to the frame body 29 and enable the welding strength to be ensured, by adjusting a relationship between the laser light L and mesh pitch of the plain-woven wire mesh 24, or arranging the laser lights L in multiplex, or otherwise.

In the aforementioned respective embodiments, if the frame body 29 has a surface enough to allow the plain-woven wire mesh 24 to be attached by the seam-welding and/or the laser-welding, its shape is not limited to a linear and quadrangular shape. For example, the frame body 29 may have a shape that is matched to a rounded opening part 23 or a shape that fits snugly to a complicated air duct between the opening part 23 and the cooling core. Because the plain-woven wire mesh 24 is attached to the frame body 29 by the seam-welding and/or the laser-welding, a work-hardening is hard to occur in the frame body 29, and it is possible to perform bending process on the frame body 29 even after the plain-woven wire mesh 24 is attached. Consequently, it becomes possible to attach the frame body 29 (screen filter 30) even to, for example, a three-dimensional opening part 23 or the like. Therefore, it is possible to provide the screen filter 30 having a shape corresponding to the curved surface of the cover member 22, which was impossible in the conventional case where the plain-woven wire mesh 24 was attached to the frame body 29 through hemming process.

Moreover, the plain-woven wire meshes 24 may be directly attached to the cover member 22 by at least either of the seam-welding and the laser-welding. In this case, the plain-woven wire meshes 24 can be directly seam-welded and/or laser-welded, by making the cover member 22 made of iron. By directly welding the plain-woven wire meshes 24 to the cover member 22 in this manner, the appearance becomes excellent, and the number of parts can be suppressed, thereby enabling the manufacture to be made at a lower cost.

Further, the plain-woven wire meshes 24 may be welded and attached not only to the cover member 22, but at any given position from the opening part 23 to the cooling core.

### INDUSTRIAL APPLICABILITY

The present invention has industrial applicability for business operators engaged in the manufacturing and sales of work machines such as hydraulic excavators comprising a filter for preventing inclusion of dust into the cooling core.

1. A work machine comprising:
a cover member configured to partition a room in which at least a part of a cooled part is housed;
an opening part formed in the cover member, and configured to take in an air for cooling the cooled part into the room;
a plain-woven wire mesh welded and attached to a position from the opening part to the cooled part, and configured to form a filter that prevents inclusion of dust into the room from the opening part.

2. The work machine according to claim 1, wherein the plain-woven wire mesh is attached by at least either one of a seam-welding and a laser-welding.

3. The work machine according to claim 1, comprising a frame body formed in a frame shape so as to surround the plain-woven wire mesh, and arranged at a position from the opening part to the cooled part, wherein the plain-woven wire mesh is attached by welding an outer edge portion to the frame body.

4. The work machine according to claim 3, wherein the frame body is formed in a frame shape by laser-welding a flat plate.

5. The work machine according to claim 1, wherein the plain-woven wire mesh is directly attached by welding to the cover member.
